(19) United States
(12) Patent Application Publication
(10) Pub. No.: US 2025/0264422 A1
(43) Pub. Date: Aug. 21, 2025

(54) Fluorescent X-ray Analysis Method and Fluorescent X-ray Analysis Apparatus

(71) Applicant: SHIMADZU CORPORATION, Kyoto-shi (JP)

(72) Inventors: Keijiro SUZUKI, Kyoto-shi (JP); Shiho YASHIMA, Kyoto-shi (JP); Kriengkamol TANTRAKARN, Kyoto-shi (JP)

(21) Appl. No.: 18/858,395

(22) PCT Filed: Feb. 24, 2023
(86) PCT No.: PCT/JP2023/006695

§ 371 Date: Oct. 21, 2024

(30) Foreign Application Priority Data
Apr. 28, 2022 (JP) 2022-074483

(51) Int. Cl. G01N 23/223

(52) U.S. Cl. CPC G01N 23/223

(57) ABSTRACT

The fluorescent X-ray analysis method includes: placing a sample in a fluorescent X-ray analysis apparatus (S1); calculating a reference tube current of an X-ray tube by applying a desired dead time rate to a paralyzed model (S3); determining a measurement tube current of the X-ray tube based on the reference tube current and irradiating the sample with X-rays generated by applying the measurement tube current to the X-ray tube (S4); and analyzing fluorescent X-rays obtained by irradiating the sample with the X-rays (S5). Thus, a desired dead time of the counting circuit can be obtained with high accuracy.

### TECHNICAL FIELD

The present disclosure relates to a fluorescent X-ray analysis method and a fluorescent X-ray analysis apparatus.

### BACKGROUND ART

The fluorescent X-ray analysis is an analysis method in which a sample is irradiated with X-rays and the fluorescent X-rays emitted from the sample are measured to analyze constituent elements of the sample. A counting circuit configured to count pulses output from an X-ray detector is used to measure the fluorescent X-rays.

For example, in the fluorescent X-ray analysis apparatus disclosed in Japanese Patent Laying-Open No. 2017-26371 (PTL 1), a variable attenuator is used to adjust a dead time of the counting circuit configured to count pulses output from the X-ray detector to an optimum value.

### CITATION LIST

### Patent Literature

PTL 1: Japanese Patent Laying-Open No. 2017-26371

### SUMMARY OF INVENTION

### Technical Problem

The fluorescent X-ray analysis apparatus disclosed in Japanese Patent Laying-Open No. 2017-26371 has such a problem that it requires a dedicated variable attenuator which is generally different from a filter and a collimator.

An object of the present disclosure is to provide a fluorescent X-ray analysis method and a fluorescent X-ray analysis apparatus capable of adjusting a dead time of a counting circuit configured to count X-rays to a target value without requiring a dedicated component.

### Solution to Problem

A first aspect of the present disclosure relates to a fluorescent X-ray analysis method for analyzing constituent elements of a sample. The fluorescent X-ray analysis method includes: placing the sample in a fluorescent X-ray analysis apparatus; calculating a reference tube current for an X-ray tube by applying a desired dead time rate to a paralyzed model; determining a measurement tube current of the X-ray tube based on the reference tube current and irradiating the sample with X-rays generated by applying the measurement tube current to the X-ray tube; and analyzing fluorescent X-rays obtained by irradiating the sample with the X-rays.

Another aspect of the present disclosure relates to a fluorescent X-ray analysis apparatus for analyzing constituent elements of a sample. The fluorescent X-ray analysis apparatus includes a sample stage on which a sample is placed, an X-ray tube configured to irradiate X-rays toward the sample stage, a detector that detects fluorescent X-rays emitted from the sample on the sample stage, and a controller that controls the X-ray tube and the detector. The controller is configured to calculate the reference tube current of the X-ray tube by applying a desired dead time rate to a paralyzed model, determine a measurement tube current of the X-ray tube based on the reference tube current, irradiate the sample with X-rays generated by applying the measurement tube current to the X-ray tube, and analyze the fluorescent X-rays detected by the detector.

### Advantageous Effects of Invention

In the fluorescent X-ray analysis method and the fluorescent X-ray analysis apparatus according to the present disclosure, since the definitive measurement is performed after the tube current is determined by applying the paralyzed model, the desired dead time of the counting circuit can be obtained with high accuracy.

### BRIEF DESCRIPTION OF DRAWINGS

FIG. 1 is a diagram schematically illustrating the entire configuration of a fluorescent X-ray analysis apparatus;

FIG. 2 is a diagram illustrating a relationship between a dead time rate and a tube current;

FIG. 3 is a flowchart illustrating a fluorescent X-ray analysis method according to a first embodiment;

FIG. 4 is a flowchart illustrating the adjustment of a tube current performed by a controller according to the first embodiment;

FIG. 5 is a flowchart illustrating a fluorescent X-ray analysis method according to a second embodiment; and

FIG. 6 is a flowchart illustrating the adjustment of a tube current performed by a controller according to the second embodiment.

### DESCRIPTION OF EMBODIMENTS

Hereinafter, embodiments of the present invention will be described in detail with reference to the drawings. It should be noted that the same or corresponding parts in the drawings are denoted by the same reference numerals, and the description thereof will not be repeated.

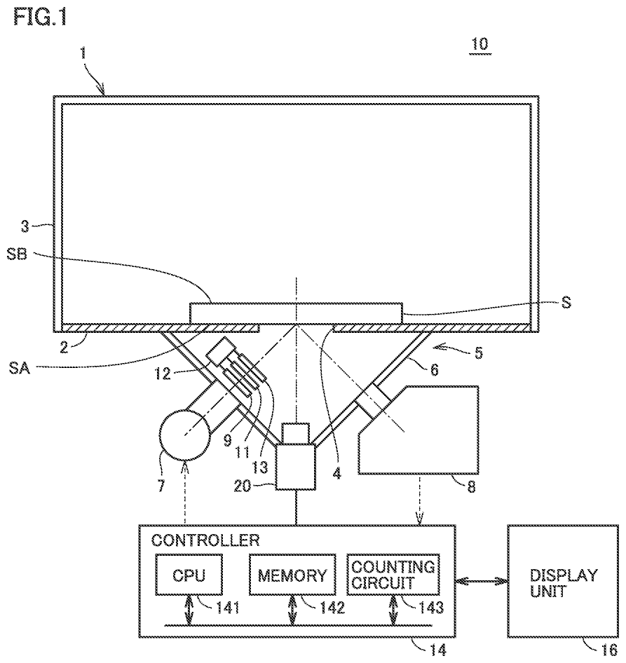

FIG. 1 is a diagram schematically illustrating the entire configuration of a fluorescent X-ray analysis apparatus. The fluorescent X-ray analysis apparatus 10 illustrated in FIG. 1 includes a sample chamber 1, a measurement chamber 5, a controller 14, and a display unit 16.

The fluorescent X-ray analysis apparatus 10 is an energy dispersive X-ray (EDX) fluorescence analysis apparatus that measures the concentration of an element contained in a sample S. The space inside the sample chamber 1 and the measurement chamber 5 is hermetically enclosed by the housing 3, and the space can be maintained in vacuum as necessary.

The sample chamber 1 includes a sample stage 2 on the bottom. The sample stage 2 is formed with a circular opening 4. The sample S is placed on the sample stage 2 so as to cover the opening 4. The sample S has a front surface SA having a measurement position and a back surface SB opposite to the front surface SA. During the measurement, the sample S is placed on the sample stage 2 in such a manner that the measurement position of the front surface SA is exposed from the opening 4.

The measurement chamber 5 includes an X-ray tube 7 and a detector 8 which are disposed on a wall surface 6. The X-ray tube 7 irradiates primary X-rays toward the sample S. The X-ray tube 7 includes a filament that emits thermal electrons and a target that converts the thermal electrons into predetermined primary X-rays and emits the primary X-rays. The primary X-rays emitted from the X-ray tube 7 are irradiated to the measurement position of the sample S through the opening 4. Secondary X-rays (fluorescent X-rays) emitted from the sample S are incident on the detector 8, and the energy and intensity of the fluorescent X-rays are measured.

A shutter 9, a primary X-ray filter 11, and a collimator 13 are installed in the measurement chamber 5. The shutter 9, the primary X-ray filter 11, and the collimator 13 may be driven to move in a direction perpendicular to the paper surface of FIG. 1 by a drive mechanism 12.

The shutter 9 is made of an X-ray absorbing material such as lead, and may be inserted into the optical path of the primary X-rays to shield the primary X-rays when necessary.

The primary X-ray filter 11 is made of a metal foil selected according to the measurement purpose, and is configured to attenuate a background component of the primary X-rays emitted from the X-ray tube 7 to improve the S/N ratio of the required characteristic X-rays. In an actual apparatus, a plurality of primary X-ray filters 11 made of different types of metals are used, and a primary X-ray filter 11 selected according to the measurement purpose is inserted into the optical path of the primary X-rays by the drive mechanism 12.

The collimator 13 is an aperture having a circular opening at the center, and is configured to define the size of a beam of the primary X-rays irradiated on the sample S. The collimator 13 is made of an X-ray absorbing material such as lead or brass. In an actual apparatus, a plurality of collimators 13 having different opening diameters are arranged side by side in a direction perpendicular to the paper surface of FIG. 1, and a collimator 13 selected according to the measurement purpose is inserted into the optical path of the primary X-rays by the drive mechanism 12.

In order to observe the measurement position of the sample S before or during the measurement, an imaging unit 20 is disposed below the measurement chamber 5. In other words, the imaging unit 20 is disposed to face the front surface SA of the sample S, and is configured to image the measurement position of the sample S through the opening 4 formed in the sample stage 2.

Before the measurement, a user who performs the fluorescent X-ray analysis displays an image acquired by the imaging unit 20 on the display unit 16, and adjusts the measurement position of the sample S based on the image. In order to manage the measurement result of the fluorescent X-rays, image data of the measurement position is stored and managed in association with the measurement result as an identifier.

The controller 14 mainly includes a central processing unit (CPU) 141 as an arithmetic processing unit. For example, a personal computer or the like may be used as the controller 14. The X-ray tube 7, the detector 8, the imaging unit 20, and the display unit 16 are connected to the controller 14.

The controller 14 controls the measurement by the fluorescent X-ray analysis apparatus 10 based on measurement conditions input from an input unit such as a keyboard, a mouse, and a touch panel integrated with the display screen of the display unit 16. Specifically, the controller 14 controls a tube voltage, a tube current, an irradiation time and the like of the X-ray tube 7, and controls the drive mechanism 12 to drive the shutter 9, the primary X-ray filter 11 and the collimator 13, respectively.

The controller 14 also acquires the secondary X-rays detected by the detector 8 and the image data from the imaging unit 20. The controller 14 performs a quantitative analysis of each element based on the spectrum of the secondary X-rays detected by the detector 8.

The display unit 16 displays an image based on the image data from the controller 14. The display unit 16 includes, for example, an LCD (Liquid Crystal Display) or an organic EL (Electro Luminescence). The display unit 16 can display an image generated by the controller 14 in addition to the image of the sample S captured by the imaging unit 20. The display unit 16 can also display the analysis result by the controller 14 together with identification information (such as the product name, the product number, and the measurement position) for identifying the sample S.

The controller 14 includes a CPU 141, a memory 142 that stores programs and data, and a counting circuit 143 that counts secondary X-rays. The memory 142 includes a read only memory (ROM), a random access memory (RAM), and a solid state drive (SSD). The SSD may be replaced with an HDD (Hard Disk Drive).

The ROM stores programs to be executed by the CPU 141. The RAM temporarily stores data to be used during the execution of a program by the CPU 141, and functions as a temporary data memory to be used as a work area. The SSD is a non-volatile storage device, and stores a measurement result obtained by the fluorescent X-ray analysis apparatus 10, image data acquired by the imaging unit 20, and information generated from the image data through image processing.

### Dead Time of Counting Circuit

It is known that a dead time is present in the counting circuit 143 configured to count the secondary X-rays. The dead time is a necessary period from a time after the counting circuit 143 has detected an event (an incidence of X-rays to the detector) to another time before the counting circuit detects another event.

The fluorescent X-ray analysis apparatus may be equipped with a measurement mode in which the tube current is adjusted in such a manner that a dead time rate [%] is constant.

However, the relationship between the tube current and the dead time rate changes depending on the optical system (the tube, the detector, the distance, or the like), the signal processing (Peaking Time, Flat top time, or the like), or the state of the sample (the weight, the base material, or the like).

### Discussion Example

For example, it is considered that the relationship between the tube current and the dead time rate may be approximated by using a quadratic equation (discussion example). In the discussion example, data that includes a set tube current and a dead time rate [%] calculated from an X-ray dose detected by the detector 8 when the tube current is applied is acquired. The manufacturer obtains data by changing the tube current at several points through experiments, obtains a relational expression approximated by a quadratic equation, and the relational expression determined by the manufacturer is implemented in the controller 14 by firmware. When the tube current is denoted by Y [μA] and the dead time rate is denoted by X [%], the relational expression in the discussion example is represented by the following equation:

$$Y = {k}_{1} {X}^{2} + {k}_{2} X + {k}_{3} .$$

The user specifies a dead time rate [%] in response to a request from the display screen of the display unit 16. Then, the controller 14 (firmware) sets a tube current estimated on the basis of the relational expression, and obtains an actual measurement value of the dead time rate [%]. The dead time rate is calculated by the controller as a ratio of an uncounted dead time to the actual time. The controller 14 adjusts the tube current so that the dead time rate falls within a certain range (±1%), and then starts the measurement at a constant tube current.

However, in the relational expression (the quadratic equation approximation), the dead time rate may not fall within a desired range, or it may take time to adjust the dead time rate to fall within the desired range.

For example, when the dose of the fluorescent X-rays (the secondary X-rays) emitted from the sample is large, the dead time rate increases. Consider a case in which the aim is to match the actual dead time rate to the target dead time rate (for example, DT=40%). As the distance between the tube and the sample and the distance between the sample and the detector become shorter, the amount of X-ray signal increases and the actual dead time rate becomes higher than the target dead time rate, whereby it is necessary to reduce the tube current. In addition, when the Peaking Time becomes shorter, the counting rate increases and the dead time rate decreases, whereby it is necessary to increase the tube current.

In addition, when the amount of the sample decreases, the entire X-ray intensity decreases, whereby it is necessary to increase the tube current. If the base material of the sample is a light element, the X-ray transmission amount increases, which may decrease the entire X-ray intensity from the sample, it is necessary to increase the tube current.

The relationship between the tube current and the dead time rate [%] depends on the optical system (the tube, the detector, the distance, or the like), the signal processing (Peaking Time, Flat Top Time, or the like), or the state of the sample (the weight, the base material, or the like). Therefore, the relationship between the tube current and the dead time rate [%] changes depending on the upgrading of the apparatus and the state of the sample.

When the relational expression, which is a quadratic expression as described above, is stored in the firmware and is used as a fixed relational expression, it is necessary to reacquire the relational expression by experiment and reflect it in the firmware every time when the apparatus is upgraded. In addition, when the state of the sample changes, the fixed equation may not converge quickly enough to adjust the current by feedback, and the analysis may take time.

### FIRST EMBODIMENT

### Application of Paralyzed Model

Therefore, in the present embodiment, it is proposed to adopt a paralyzed model (an extended dead time model in which after one pulse is output, if the next incoming x-ray is received within the dead time, the counting system outputs a signal in which the latter pulse is connected to the former pulse and a response is associated with a pulse) to calculate the parameter “a”, which is the factor of the relational expression between the tube current and the dead time rate [%], from the preliminary measurement.

The following equation holds between the tube current A and the dead time rate DT [%] in the case of a paralyzed model.

$$A = a * ln ( 100 / ( 100 - DT ) )$$

Wherein, “a” represents a parameter. “a” corresponds to a tube current when the OCR (Output Count Rate) is maximum.

Prior to the every actual measurement, the controller 14 acquires the values of the tube current A and the dead time rate DT [%] at one or more points in preliminary measurement, and performs calculations to be described later to calculate the parameter “a”.

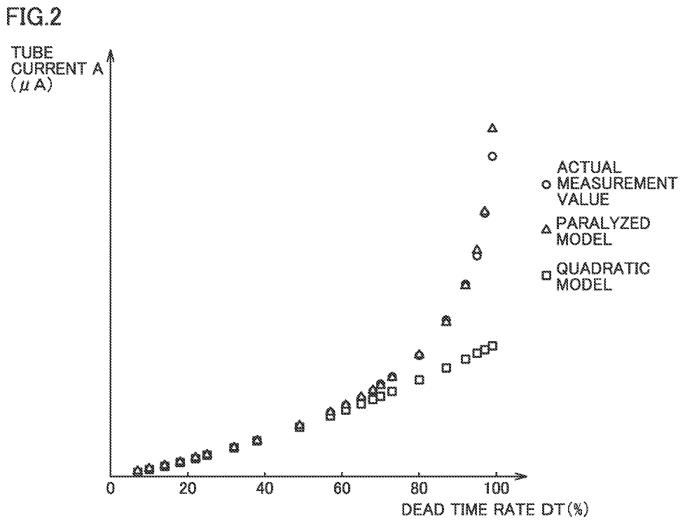

FIG. 2 is a diagram illustrating a relationship between the dead time rate and the tube current. A circle mark (O) indicates an actual measurement value, a triangle mark (Δ) indicates a value estimated by a paralyzed model, and a square mark (□) indicates a value estimated by a quadratic equation approximation. The paralyzed model is a model in which the parameter “a” is determined from data at two points of the tube current A=10 μA and 100 μA. The quadratic equation is a model obtained by approximation using data with the dead time rate up to DT=49%.

As illustrated in FIG. 2, the value estimated by the paralyzed model shows good agreement with the actual measurement value for the entire region, whereas the value estimated by the quadratic equation approximation described in the discussion example deviates from the actual measurement value when the dead time rate DT exceeds 50%.

According to the present embodiment, even when the desired dead time rate DT is equal to or greater than 50%, the tube current A that achieves the desired dead time rate DT can be estimated with high accuracy. The equation (2) described later may be transformed based on a high dead time rate and a recorded count rate “m” to obtain a high true count rate “n” to increase the sensitivity.

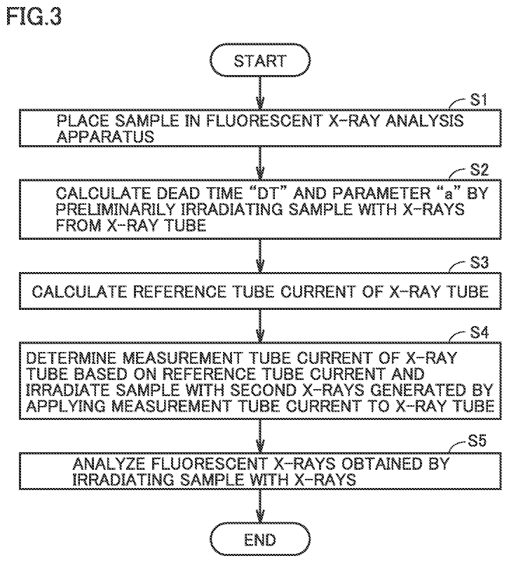

FIG. 3 is a flowchart illustrating a fluorescent X-ray analysis method according to the first embodiment. The user analyzes constituent elements of a sample by the fluorescent X-ray analysis method to be described below.

The flow of the fluorescent X-ray analysis method will be described with reference to FIGS. 1 and 3. First, in step S1, the user places a sample S to be analyzed in the fluorescent X-ray analysis apparatus 10.

Subsequently, in step S2, the controller 14 preliminarily irradiates the sample S with X-rays from the X-ray tube 7, and calculates the dead time rate DT corresponding to the irradiated X-rays so as to calculate the parameter “a” of the paralyzed model. The calculation of the parameter “a” by the irradiation of X-rays at this time is referred to as the preliminary measurement.

Subsequently, in step S3, the controller 14 calculates a reference tube current of the X-ray tube 7 by applying the desired dead time rate DT given by the user to the above-described equation of the paralyzed model incorporated with the parameter “a”.

Subsequently, in step S4, the controller 14 determines a measurement tube current of the X-ray tube 7 based on the reference tube current calculated in step S3, and irradiates the sample S with X-rays generated by applying the measurement tube current to the X-ray tube 7. The irradiation of X-rays and the detection of fluorescent X-ray by the detector 8 based on the irradiation of X-rays at this time are referred to as the definitive measurement.

In step S5, the controller 14 analyzes the fluorescent X-rays generated by irradiating the sample S with the X-rays. Then, the controller 14 displays the analysis result on the display unit 16.

When the reference tube current is denoted by A, the dead time rate is denoted by DT, and the predetermined parameter is denoted by “a”, the paralyzed model used in step S2 is represented by the following equation:

$$A = a * ln ( 100 / ( 100 - DT ) ) .$$

The parameter “a” can be calculated by obtaining a combination (DT, A) of the dead time rate DT [%] and the tube current A at one or more points in the preliminary measurement and performing the calculations to be described below.

In the paralyzed model, the relationship between a true input count rate (ICR) n, a recorded output count rate (OCR) m, and a dead time t is represented by the following equation (1), and the dead time rate DT [%] is represented by the following equation (2).

$$[ Equation 1 ]$$

$$m = {ne}^{- n τ} \qquad ( 1 )$$

$$[ Equation 2 ]$$

$$DT [ \% ] = \frac{n - m}{m} * 100 = ( 1 - \frac{m}{n} ) * 100 \qquad ( 2 )$$

The equation (3) in the following is obtained by substituting the equation (1) into the equation (2).

$$[ Equation 3 ]$$

$$DT [ \% ] = ( 1 - \frac{{ne}^{- n τ}}{n} ) * 100 = ( 1 - {e}^{- n τ} ) * 100 \qquad ( 3 )$$

As the tube current increases, the OCR increases to a maximum value and then decreases. When the true input count rate n is equal to 1/τ to provide the maximum value I_{maxocr}, the equation (1) is transformed to obtain the following equations (4), (5), and (6).

$$[ Equation 4 ]$$

$${I}_{maxocr} = {ne}^{- n τ} = \frac{1}{τ} {e}^{( - \frac{1}{τ} * τ )} = \frac{1}{τ} {e}^{- 1} = \frac{1}{e τ} \qquad ( 4 )$$

$$[ Equation 5 ]$$

$${I}_{maxocr} = \frac{1}{e τ} \qquad ( 5 )$$

$$[ Equation 6 ]$$

$$τ = \frac{1}{e * {I}_{maxocr}} \qquad ( 6 )$$

Since n is proportional to the tube current A, and the proportional coefficient is denoted by k. Substituting n=k*A and the proportional coefficient k=e*I_{maxocr}/a into the equation (1) to transform the equation (1) into the equations (7) to (11) sequentially.

$$[ Equation 7 ]$$

$$n = k * A = \frac{e * {I}_{maxocr}}{a} * A \qquad ( 7 )$$

$$[ Equation 8 ]$$

$$DT [ \% ] = ( 1 - {e}^{- n τ} ) * 100 \qquad ( 8 )$$

$$[ Equation 9 ]$$

$$DT [ \% ] = ( 1 - {e}^{- \frac{e * {I}_{maxocr}}{a} * A * \frac{1}{e * {I}_{maxocr}}} ) * 100 \qquad ( 9 )$$

$$[ Equation 10 ]$$

$$DT [ \% ] = ( 1 - {e}^{- \frac{A}{a}} ) * 100 \qquad ( 10 )$$

$$[ Equation 11 ]$$

$$A = a * ln ( \frac{100}{100 - DT} ) \qquad ( 11 )$$

The parameter “a” is calculated from the combination (DT₁, A₁) of the tube current A and the dead time rate DT. First, the equation (11) is transformed to obtain the equation (12).

$$[ Equation 12 ]$$

$$a = \frac{A}{ln ( \frac{100}{100 - DT} )} \qquad ( 12 )$$

The combination (DT₁, A₁) is applied to the equation (12) to obtain the equation (13).

$$[ Equation 13 ]$$

$$a = \frac{{A}_{1}}{ln ( \frac{100}{100 - {DT}_{1}} )} \qquad ( 13 )$$

When the combination of the tube current A and the dead time rate DT are two points of (DT₁, A₁) and (DT₂, A₂), the parameter “a” is calculated by the least squares method. In this case, the parameter “a” is obtained so that the sum of squares of errors is minimum.

$$[ Equation 14 ]$$

$$Sum of squares of errors = {\sum }_{i} {( {A}_{i} - a * ln ( \frac{100}{100 - {DT}_{i}} ) )}^{2} \qquad ( 14 )$$

In the equation (14), i=1, 2. When both sides of the equation (14) are differentiated with “a” under the condition that the error is minimum, the equation (15) is obtained.

$$[ Equation 15 ]$$

$$0 = a {\sum }_{i} 2 {( ln ( \frac{100}{100 - {DT}_{i}} ) )}^{2} - 2 {\sum }_{i} ( {A}_{i} * ln ( \frac{100}{100 - {DT}_{i}} ) ) \qquad ( 15 )$$

The equation (15) is transformed to obtain equations (16) and (17).

$$[ Equation 16 ]$$

$$a = \frac{{\sum }_{i} ( {A}_{i} * ln ( \frac{100}{100 - {DT}_{i}} ) )}{{\sum }_{i} {( ln ( \frac{100}{100 - {DT}_{i}} ) )}^{2}} \qquad ( 16 )$$

$$[ Equation 17 ]$$

$$a = \frac{{A}_{1} * ln ( \frac{100}{100 - {DT}_{1}} ) + {A}_{2} * ln ( \frac{100}{100 - {DT}_{2}} )}{{( ln ( \frac{100}{100 - {DT}_{1}} ) )}^{2} + {( ln ( \frac{100}{100 - {DT}_{2}} ) )}^{2}} \qquad ( 17 )$$

When the combination of the dead time rate DT and the tube current A is only one (DT₁, A₁), the equation (16) is the same as the equation (13). When there are a plurality of combinations, i may increase along with the number of combinations i=1, 2, 3 . . . in the equation (16).

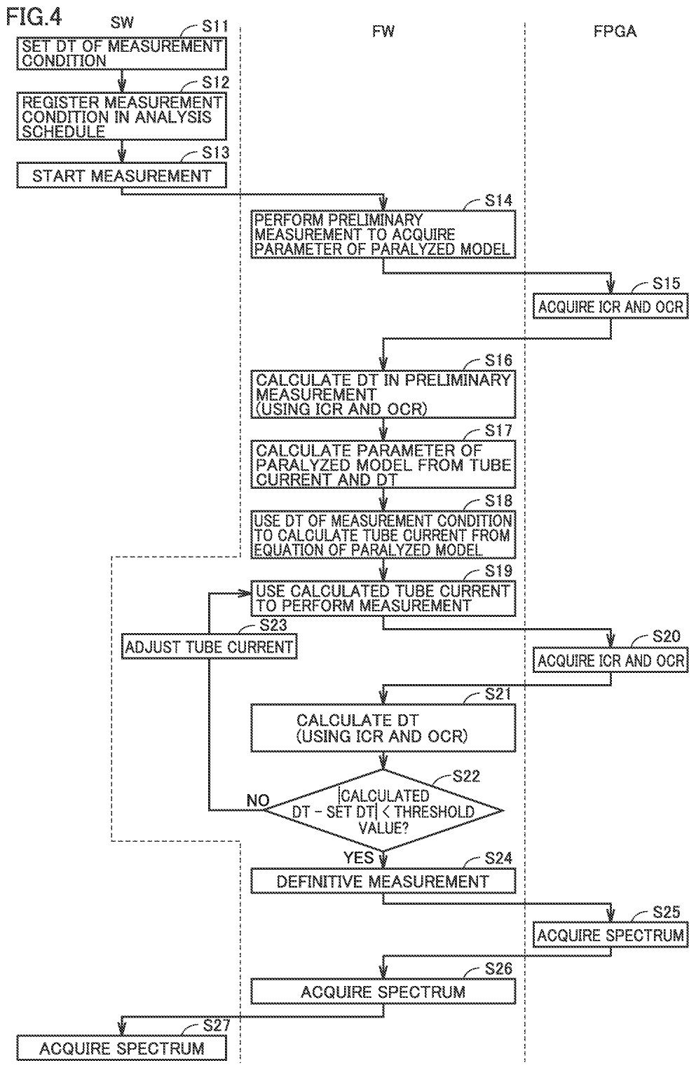

FIG. 4 is a flowchart illustrating the adjustment of a tube current performed by a controller according to the first embodiment. In the flowchart of FIG. 4, SW denotes software, FW denotes firmware, and FPGA (Field-Programmable Gate Array) denotes an integrated circuit that can be configured by a purchaser or a designer after manufacture. However, the roles illustrated in FIG. 4 are merely given as examples, and these roles can be appropriately changed, and are not intended to limit the present embodiment.

First, in step S11, the user inputs to the controller 14 a desired dead time rate DT that meets the measurement condition. The controller 14 registers the measurement condition in the analysis schedule, and starts the measurement in step S13.

After the start of the measurement, the controller 14 performs a preliminary measurement to acquire the parameter “a” of the paralyzed model in step S14. In the preliminary measurement, one to three combinations of the tube current A and the dead time rate DT are acquired to calculate the parameter “a” that determines the relationship between the dead time rate DT and the tube current A. The parameter “a” may change depending on the amount of the sample, the type of the sample, the optical system, or the signal processing system. Therefore, although not necessarily limited, the frequency of calculating the parameter “a” is preferably calculated every time when the sample S is placed on the sample stage.

When the tube current is automatically adjusted, DT [%] is sent to the controller to determine the tube current A by the automatic adjustment. The tube current A estimated from the dead time rate DT is set from the FW (firmware), ICR and OCR are acquired from the FPGA (S15), and the dead time rate DT is calculated in the preliminary measurement (S16).

Then, in step S17, the tube current A determined in the preliminary measurement and the calculated dead time rate DT are substituted into the equation (13) or the equations (16) and (17) to calculate the parameter “a”. Then, in step S18, the dead time rate DT in the measurement condition is used to calculate the tube current A from the paralyzed model A=a*ln(100/(100−DT)) in which the parameter “a” is determined.

Then, the calculated tube current A is applied to the X-ray tube 7 in step S19, ICR and OCR are acquired from the FPGA (S20), and the dead time rate DT is calculated after the parameter “a” is determined in the preliminary measurement (S21).

In step S22, a difference between the dead time rate DT set in step S11 and the dead time rate DT calculated in step S21 is calculated. If the difference is greater than a threshold value (for example, 1%) (NO in S22), the tube current A is adjusted in step S23. However, if an upper limit current (for example, 1000 μA) is set, the measurement is terminated or the measurement is performed at the upper limit current.

When the estimated tube current A is calculated from the dead time rate DT, it is expected that the adjustment of the tube current A in steps S22 and S23 converges faster in the relational expression of the paralyzed model to which the parameter “a” is applied according to the amount of the sample after the preliminary measurement rather than the relational expression of the quadratic model fixed in the firmware.

If the difference is smaller than the threshold value (YES in S22), the definitive measurement is performed in step S24 using the determined tube current A. Then, the spectrum of the fluorescent X-rays emitted from the sample S is acquired (steps S25 to S27), and the analysis result is displayed on the display unit 16.

According to the fluorescent X-ray analysis method and the fluorescent X-ray analysis method described in the present embodiment, the tube current A can be automatically adjusted without recalculating the relational expression between the tube current A and the dead time rate DT [%] by experiment every time when the apparatus is upgraded.

Further, even if the state of the sample S changes, the parameter “a” can be adjusted dynamically, and thereby the tube current A can be adjusted rapidly and automatically. Although not limited, it is preferable to perform a preliminary measurement every time when the definitive measurement is performed to determine the parameter “a”.

### SECOND EMBODIMENT

In the first embodiment, the quadratic equation used in the discussion example is (Y=k₁X²+k₂X+k₃), and there are three parameters of k₁, k₂ and k₃, but the number of parameters is reduced to one by the application of the paralyzed model, i.e., “a” represented by the equation (12).

In the first embodiment, the parameter “a” is calculated by the equation (16) so as to adjust the tube current A by using the parameter “a”, but it is also possible to directly calculate the target tube current, for obtaining the target dead time rate, from the dead time rate and the tube current during the preliminary measurement without using the parameter “a”.

Substituting the preliminary measurement value and the target value into the equation (11) to obtain two equations and dividing corresponding sides of the two equations to obtain the following equation (18).

$$ln ( 100 / ( 100 - {DT}_{1} ) ) / ln ( 100 / ( 100 - {DT}_{2} ) ) = {A}_{1} / {A}_{2} \qquad ( 18 )$$

DT₁: target dead time rate, A₁: target tube current value
DT₂: preliminarily measured dead time rate, A₂: preliminarily measured tube current value

The target tube current is obtained by the following equation (19) transformed from the equation (18).

$${A}_{1} = {A}_{2} * ln ( 100 / ( 100 - {DT}_{1} ) ) / ln ( 100 / ( 100 - {DT}_{2} ) ) \qquad ( 19 )$$

When the equation (19) is used, the parameter “a” is not needed, and thereby the tube current can be predicted from the dead time DT without depending on the primary filter, the sample material, the collimator, and the like.

According to the experimental results of the inventors of the present invention, the adjustment of the tube current by the target dead time DT according to the equation (19) showed good result.

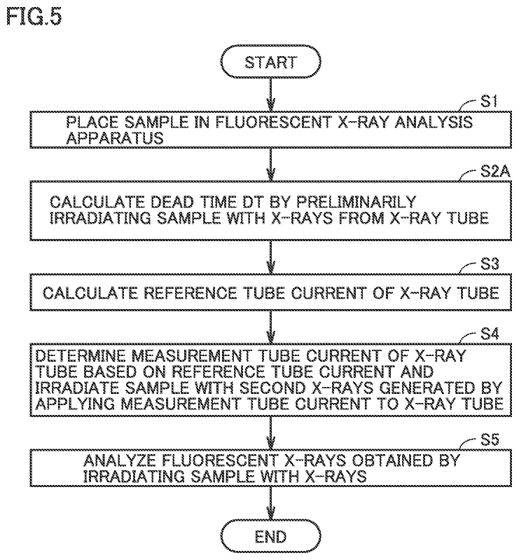

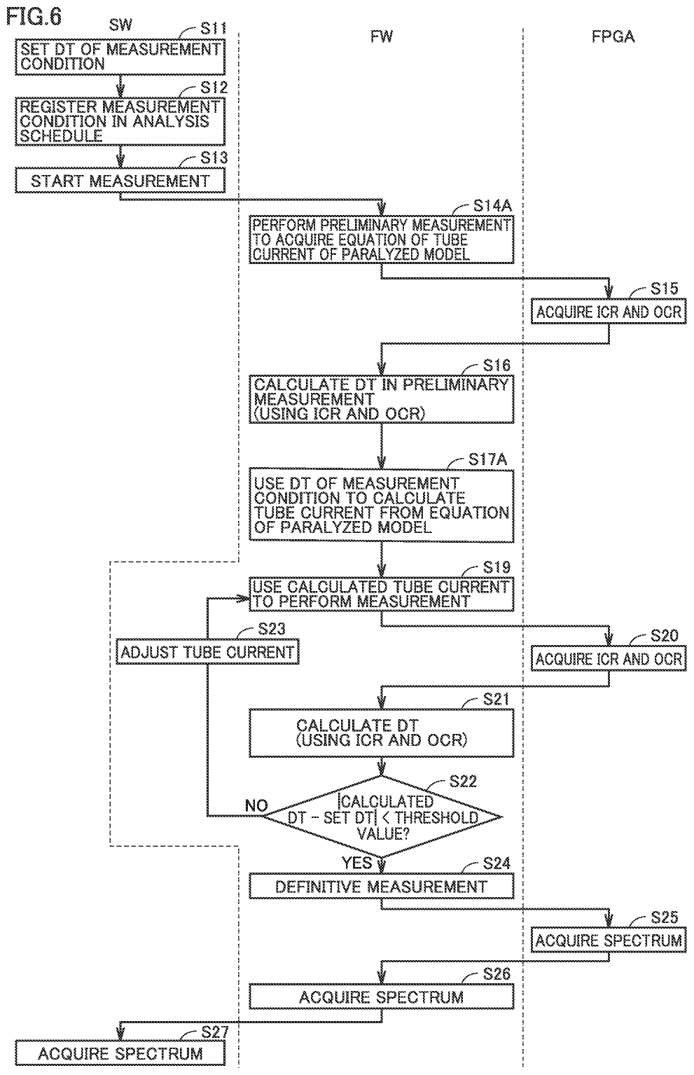

In the second embodiment, the use of the equation (19) can simplify a part of the steps of adjusting the tube current. FIG. 5 is a flowchart illustrating a fluorescent X-ray analysis method according to the second embodiment. In the flowchart illustrated in FIG. 5, step S2A is performed instead of step S2 in the flowchart illustrated in FIG. 3. In step S2A, the calculation of the parameter “a” is no longer necessary. FIG. 6 is a flowchart illustrating the adjustment of a tube current performed by a controller according to the second embodiment. In the flowchart illustrated in FIG. 6, step S17A is performed instead of steps S17 and S18 in the flowchart illustrated in FIG. 4.

In step S17, DT calculated in the preliminary measurement in step S16 is substituted into DT₂ of the equation (19) to obtain a tube current A₁ corresponding to the target dead time DT₁. As described above, in the second embodiment, it is no longer necessary to calculate the parameter “a” of the paralyzed model.

### ASPECTS

It will be understood by those skilled in the art that the exemplary embodiments described above are specific examples of the following aspects.
(1) A first aspect of the present disclosure relates to a fluorescent X-ray analysis method for analyzing constituent elements of a sample. The fluorescent X-ray analysis method includes: placing the sample in a fluorescent X-ray analysis apparatus; calculating a reference tube current for an X-ray tube by applying a desired dead time rate to a paralyzed model; determining a measurement tube current of the X-ray tube based on the reference tube current and irradiating the sample with X-rays generated by applying the measurement tube current to the X-ray tube; and analyzing fluorescent X-rays obtained by irradiating the sample with the X-rays.
(2) In the fluorescent X-ray analysis method described above in (1), preferably, when the reference tube current is denoted by A, the dead time rate is denoted by DT, and a predetermined parameter is denoted by a, the paralyzed model is represented by

$$A = a * ln ( 100 / ( 100 - DT ) ) .$$

(3) In the fluorescent X-ray analysis method described above in (2), more preferably, the fluorescent X-ray analysis method further includes calculating the parameter by preliminarily irradiating the sample with X-rays from the X-ray tube. In calculating the reference tube current, the reference tube current is calculated by applying the desired dead time rate to the paralyzed model incorporated with the parameter.
(4) In the fluorescent X-ray analysis method described above in (1), preferably, the fluorescent X-ray analysis method further includes measuring a dead time by irradiating the sample with X-rays generated by applying a preliminary test tube current to the X-ray tube.

When the reference tube current is denoted by A₁, the desired dead time rate is denoted by DT₁, the preliminary test tube current is denoted by A₂, and the dead time measured by applying the preliminary test tube current is denoted by DT₂, the reference tube current is represented by A₁=A₂*ln(100/(100−DT₁))/ln(100/(100−DT₂)).
(5) In the fluorescent X-ray analysis method described above in (1), preferably, in irradiating the sample with X-rays, a dead time rate is calculated by irradiating the sample with X-rays generated by applying the reference tube current to the X-ray tube, and the measurement tube current is determined by adjusting the reference tube current based on a difference between the calculated dead time rate and the desired dead time rate.
(6) Another aspect of the present disclosure relates to a fluorescent X-ray analysis apparatus for analyzing constituent elements of a sample. The fluorescent X-ray analysis apparatus includes a sample stage on which a sample is placed, an X-ray tube configured to irradiate X-rays toward the sample stage, a detector that detects fluorescent X-rays emitted from the sample on the sample stage, and a controller that controls the X-ray tube and the detector. The controller is configured to calculate the reference tube current of the X-ray tube by applying a desired dead time rate to a paralyzed model, and determine a measurement tube current of the X-ray tube based on the reference tube current, irradiate the sample with X-rays generated by applying the measurement tube current to the X-ray tube, and analyze the fluorescent X-rays detected by the detector.
(7) In the fluorescent X-ray analysis apparatus described above in (6), preferably, when the reference tube current is denoted by A, the dead time rate is denoted by DT, and a predetermined parameter is denoted by a, the paralyzed model is represented by A=a*ln(100/(100−DT)).
(8) In the fluorescent X-ray analysis apparatus described above in (7), more preferably, the controller is configured to calculate the parameter by preliminarily irradiating the sample with X-rays from the X-ray tube, and calculate the reference tube current by applying the desired dead time rate to the paralyzed model incorporated with the parameter.
(9) In the fluorescent X-ray analysis apparatus described above in (6), preferably, the controller is configured to measure a dead time by irradiating the sample with X-rays generated by applying a preliminary test tube current to the X-ray tube. When the reference tube current is denoted by A₁, the desired dead time rate is denoted by DT₁, the preliminary test tube current is denoted by A₂, and the dead time measured by applying the preliminary test tube current is denoted by DT₂, the reference tube current is represented by A₁=A₂*ln(100/(100−DT₁))/ln(100/(100−DT₂)).
(10) In the fluorescent X-ray analysis apparatus described above in (6), preferably, the controller is configured to calculate a dead time rate by irradiating the sample with X-rays generated by applying the reference tube current to the X-ray tube, and determine the measurement tube current by adjusting the reference tube current based on a difference between the calculated dead time rate and the desired dead time rate.
(11) The fluorescent X-ray analysis apparatus described above in (6) preferably further includes at least one of an X-ray filter and a collimator disposed on an X-ray irradiation path from the X-ray tube to the sample stage. At least one of the X-ray filter and the collimator is selected as an analysis element from a plurality of types of elements.

Note that the components described in each embodiment of the present specification may be appropriately combined.

It should be understood that the embodiments disclosed herein are illustrative and non-restrictive in all respects. The scope of the present invention is defined by the terms of the claims rather than the description of the embodiments above, and is intended to include any modifications within the scope and meaning equivalent to the terms of the claims.

### REFERENCE SIGNS LIST

1: sample chamber; 2: sample stage; 3: housing; 4: opening; 5: measurement chamber; 6: wall surface; 7: X-ray tube; 8: detector; 9: shutter; 10: X-ray analysis apparatus; 11: X-ray filter; 12: drive mechanism; 13: collimator; 14: controller; 16: display unit; 20: imaging unit; 100: X-ray analysis system; 142: memory; 143: counting circuit; S: sample; SA: front surface; SB: back surface.

1. A fluorescent X-ray analysis method for analyzing constituent elements of a sample, the fluorescent X-ray analysis method comprising:
placing the sample in a fluorescent X-ray analysis apparatus;
calculating a reference tube current for an X-ray tube by applying a desired dead time rate to a paralyzed model;
determining a measurement tube current of the X-ray tube based on the reference tube current and irradiating the sample with X-rays generated by applying the measurement tube current to the X-ray tube; and
analyzing fluorescent X-rays obtained by irradiating the sample with the X-rays.

2. The fluorescent X-ray analysis method according to claim 1, wherein
when the reference tube current is denoted by A, the dead time rate is denoted by DT, and a predetermined parameter is denoted by a, the paralyzed model is represented by A=a*ln(100/(100−DT)).

3. The fluorescent X-ray analysis method according to claim 2, further comprising:
calculating the parameter by preliminarily irradiating the sample with X-rays from the X-ray tube, wherein
in the calculating the reference tube current, the reference tube current is calculated by applying the desired dead time rate to the paralyzed model incorporated with the parameter.

4. The fluorescent X-ray analysis method according to claim 1, further comprising:
measuring a dead time by irradiating the sample with X-rays generated by applying a preliminary test tube current to the X-ray tube, wherein
when the reference tube current is denoted by A₁, the desired dead time rate is denoted by DT₁, the preliminary test tube current is denoted by A₂, and the dead time measured by applying the preliminary test tube current is denoted by DT₂, the reference tube current is represented by A₁=A₂*ln(100/(100−DT₁))/ln(100/(100−DT₂)).

5. The fluorescent X-ray analysis method according to claim 1, wherein
in the irradiating the sample with X-rays, a dead time rate is calculated by irradiating the sample with X-rays generated by applying the reference tube current to the X-ray tube, and the measurement tube current is determined by adjusting the reference tube current based on a difference between the calculated dead time rate and the desired dead time rate.

6. A fluorescent X-ray analysis apparatus for analyzing constituent elements of a sample, the fluorescent X-ray analysis apparatus comprising:
a sample stage on which a sample is placed;
an X-ray tube configured to irradiate X-rays toward the sample stage;
a detector that detects fluorescent X-rays emitted from the sample on the sample stage; and
a controller that controls the X-ray tube and the detector,
the controller being configured to:
calculate the reference tube current of the X-ray tube by applying a desired dead time rate to a paralyzed model, and
determine a measurement tube current of the X-ray tube based on the reference tube current, irradiate the sample with X-rays generated by applying the measurement tube current to the X-ray tube, and analyze the fluorescent X-rays detected by the detector.

7. The fluorescent X-ray analysis apparatus according to claim 6, wherein
when the reference tube current is denoted by A, the dead time rate is denoted by DT, and a predetermined parameter is denoted by a, the paralyzed model is represented by A=a*ln(100/(100−DT)).

8. The fluorescent X-ray analysis apparatus according to claim 7, wherein
the controller is configured to calculate the parameter by preliminarily irradiating the sample with X-rays from the X-ray tube, and calculate the reference tube current by applying the desired dead time rate to the paralyzed model incorporated with the parameter.

9. The fluorescent X-ray analysis apparatus according to claim 6, wherein
the controller is configured to measure a dead time by irradiating the sample with X-rays generated by applying a preliminary test tube current to the X-ray tube,
when the reference tube current is denoted by A₁, the desired dead time rate is denoted by DT₁, the preliminary test tube current is denoted by A₂, and the dead time measured by applying the preliminary test tube current is denoted by DT₂, the reference tube current is represented by A₁=A₂*ln(100/(100−DT₁))/ln(100/(100−DT₂)).

10. The fluorescent X-ray analysis apparatus according to claim 6, wherein
the controller is configured to calculate a dead time rate by irradiating the sample with X-rays generated by applying the reference tube current to the X-ray tube, and determine the measurement tube current by adjusting the reference tube current based on a difference between the calculated dead time rate and the desired dead time

11. The fluorescent X-ray analysis apparatus according to claim 6, further comprising:
at least one of an X-ray filter and a collimator disposed on an X-ray irradiation path from the X-ray tube to the sample stage,
wherein at least one of the X-ray filter and the collimator is selected as an analysis element from a plurality of types of elements.
